(19) United States
(12) Patent Application Publication
(10) Pub. No.: US 2025/0225367 A1
(43) Pub. Date: Jul. 10, 2025

(54) INFORMATION PROCESSING DEVICE

(71) Applicant: TDK Corporation, Tokyo (JP)

(72) Inventor: Eiji SUZUKI, Tokyo (JP)

(73) Assignee: TDK Corporation, Tokyo (JP)

(21) Appl. No.: 18/761,540

(22) Filed: Jul. 2, 2024

Related U.S. Application Data
(60) Provisional application No. 63/617,828, filed on Jan. 5, 2024.

(51) Int. Cl. G06N 3/044

(52) U.S. Cl. CPC G06N 3/044

(57) ABSTRACT

An information processing device according to the present disclosure includes an input unit, an information processing unit, and an output unit. The information processing unit includes a physical element of which resistance or conductance changes in accordance with application of a voltage or a current. The input unit is configured to be able to input an input signal and a control signal to the physical element. The input signal is a signal for changing the resistance or the conductance of the physical element on the basis of input information. The control signal is a signal for changing a change speed of the resistance or the conductance of the physical element. The output unit is configured to receive a signal from the physical element and output an output signal.

### BACKGROUND OF THE INVENTION

### Field of the Invention

The present disclosure relates to an information processing device.

### Description of Related Art

In recent years, artificial intelligence (AI) has attracted attention. As one technology that cannot be missed in AI, there is a neural network. A neural network is a mathematical model that artificially imitates a relation between neurons and synapses in the human brain.

A neural network, for example, includes nodes (neurons in the brain) arranged in a hierarchy and transmission means (synapses in the brain) connecting such nodes. In a neural network, the transmission means (synapses) perform learning, whereby a correct answer rate of a problem is raised. The learning is executed such that weights of transmission means (synapses) are optimized for acquiring a desired output.

In arithmetic operations in a neural network, the load of the arithmetic operations is high, and there are cases in which sufficient processing efficiency cannot be acquired even when all the arithmetic operations are mathematically performed. For this reason, substitution of some of mathematical operations in a neural network with a physical element has been reviewed. For example, in Patent Document 1, a physical element using nano particles is disclosed. This element is responsible for some arithmetic operations of a neural network.

### PATENT DOCUMENTS

[Patent Document 1] Published Japanese Translation No. 2018-530145 of the PCT International Publication

### SUMMARY OF THE INVENTION

An information processing device according to the present disclosure includes an input unit, an information processing unit, and an output unit. The information processing unit includes a physical element of which resistance or conductance changes in accordance with application of a voltage or a current. The input unit is configured to be able to input an input signal and a control signal to the physical element. The input signal is a signal for changing the resistance or the conductance of the physical element on the basis of input information. The control signal is a signal for changing a change speed of the resistance or the conductance of the physical element. The output unit is configured to receive a signal from the physical element and output an output signal.

### BRIEF DESCRIPTION OF THE DRAWINGS

FIG. 1 is a conceptual diagram of a neural network simulated by an information processing device according to a first embodiment.

FIG. 2 is a configuration diagram of the information processing device according to the first embodiment.

FIG. 3 is a diagram illustrating one example of a physical element configuring the information processing device according to the first embodiment.

FIG. 4 is a diagram illustrating one example of an input signal and a control signal of the information processing device according to the first embodiment.

FIG. 5 is a diagram representing a relation between a control signal applied to a physical element and a relaxation time of the physical element in the information processing device according to the first embodiment.

FIG. 6 is a configuration diagram of a first modified example of the information processing device according to the first embodiment.

FIG. 7 is a diagram illustrating another example of an input signal and a control signal of the information processing device according to the first embodiment.

FIG. 8 is a plan view of another example of a physical element configuring the information processing device.

FIG. 9 is a cross-sectional view of another example of a physical element configuring the information processing device.

FIG. 10 is a configuration diagram of an information processing device according to a fourth embodiment.

### DETAILED DESCRIPTION OF THE INVENTION

Here, the present disclosure will be described in detail by appropriately referring to the drawings. In the drawings used in the following description, for easy understanding of features of the present disclosure, parts that become features may be represented in an enlarged scale, and an aspect ratio and the like of each constituent element may be different from actual values. Materials, sizes, and the like illustrated in the following description are examples, but the present disclosure is not limited thereto, and they may be appropriately changed in a range in which effects of the present disclosure are obtained.

When a neural network is substituted with a physical element, there is a problem that it is difficult to design short term memory property of the physical element. The short term memory property is a scale representing how much past information can be memorized and forgotten.

A neural network having optimal short term memory property for a given task outputs an estimated solution by taking data of a necessary section before the present in time series data into account and ignoring past data that is older than is necessary. For example, as one neural network, a recurrent neural network is known. A recurrent neural network can handle data of a nonlinear time series. Data of a nonlinear time series is data of which a value changes in accordance with elapse of time, and a stock price and the like are examples thereof. An estimated solution output by a recurrent neural network differs in accordance with short term memory property.

The present disclosure is in consideration of the situations described above and provides an information processing device capable of designing short term memory property.

### First Embodiment

An information processing device according to this embodiment is acquired by forming a mathematical neural network as a device.

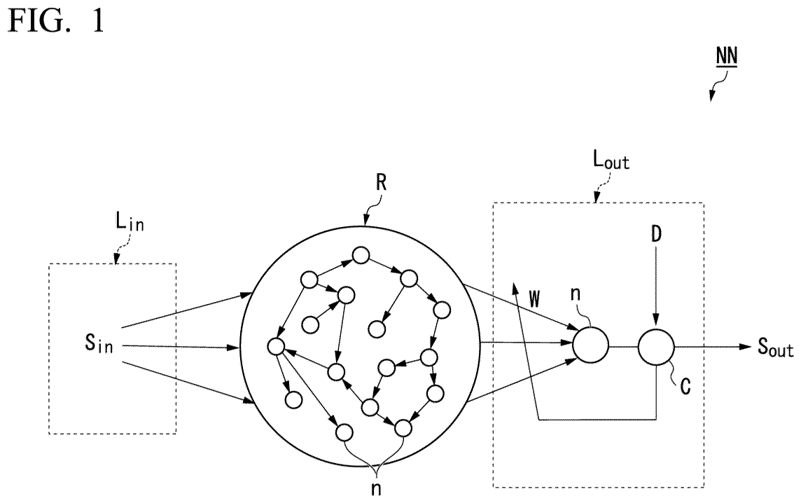

FIG. 1 is a conceptual diagram of one example of a neural network simulated by the information processing device according to the first embodiment. The neural network NN illustrated in FIG. 1 is reservoir computing. Reservoir computing is one means for realizing a recurrent neural network. Reservoir computing can represent complex dynamics by causing signals to interact with each other on the basis of internal connections including recurrent connections.

The neural network NN illustrated in FIG. 1 has an input layer Lᵢₙ, a reservoir layer R, and an output layer Lₒᵤₜ. The input layer Lᵢₙ and the output layer Lₒᵤₜ are connected to the reservoir layer R.

The input layer Lᵢₙ inputs an input signal Sᵢₙ to the reservoir layer R. The input signal Sᵢₙ, for example, is a signal sensed by a sensor. The input signal Sᵢₙ may be either an analog signal or a digital signal. The input signal Sᵢₙ may be composed of a plurality of signals.

The input signal Sᵢₙ, for example, is a time series signal. The time series signal, for example, may be divided for each time domain and input as a plurality of signals. An input signal may be input as it is without being processed, or a signal that has undergone Fast Fourier Transform Analysis (FFT analysis) may be input. Frequency characteristics are extracted in the FFT analysis. In addition, small-amplitude signals due to noise can be filtered in the FFT analysis.

The reservoir layer R stores an input signal Sᵢₙ input from the input layer Lᵢₙ and converts the input signal into another signal. Inside the reservoir layer R, the input signal Sᵢₙ changes nonlinearly. The input signals Sᵢₙ interact with each other inside the reservoir layer R and thus change in accordance with elapse of time. Here, signals interacting with each other represents that a signal that has propagated to a certain node n has an effect on a signal propagating to another node n. The reservoir layer R projects an input signal Sᵢₙ into a multi-dimensional nonlinear space. Inside the reservoir layer R, although the input signal Sᵢₙ is substituted with another signal, at least some information included in the input signal Sᵢₙ changes in form and is included in the signal after conversion.

Inside the reservoir layer R, a plurality of nodes n are present. The number of nodes n is not particularly limited. The more nodes n there are, the greater the expression power of the reservoir layer R. The node N corresponds to a neuron of a neural circuit, and a connection between nodes n corresponds to a synapse.

Although a plurality of nodes n are randomly connected in many cases, by optimizing connection weights between nodes n and topology in advance, a connection relation among the plurality of nodes n and connection coefficients may be determined on the basis thereof. Inside the reservoir layer R, as connection weights between respective nodes n, fixed values set using random numbers or the like are taken, and connection weights between respective nodes n are generally not a target for learning.

For example, there are cases in which a signal output from one node n at a time t returns to a node n that has output a signal at a time t+1. Since the node n performs a process based on the signals of the time t and the time t+1, information is recursively processed inside the reservoir layer R.

A signal from the reservoir layer R is input to the output layer Lₒᵤₜ, and the output layer outputs an output signal Sₒᵤₜ based on the signal. The output layer Lₒᵤₜ has weights W used for weighted calculation of outputs of the reservoir layer R and performs inference using the weights W. In addition, the output layer Lₒᵤₜ optimizes the weights W using a learning process. In the learning process, the output layer Lₒᵤₜ compares an output from the reservoir layer R with teacher data D using a comparator C and adjusts weights W applied between the node n of this reservoir layer R and the node n of the output layer Lₒᵤₜ. The weights W are determined at the time of performing a learning process. In an inference process, the output layer Lₒᵤₜ outputs a result of inference based on the input signal Sᵢₙ and the weight W as an output signal Sₒᵤₜ.

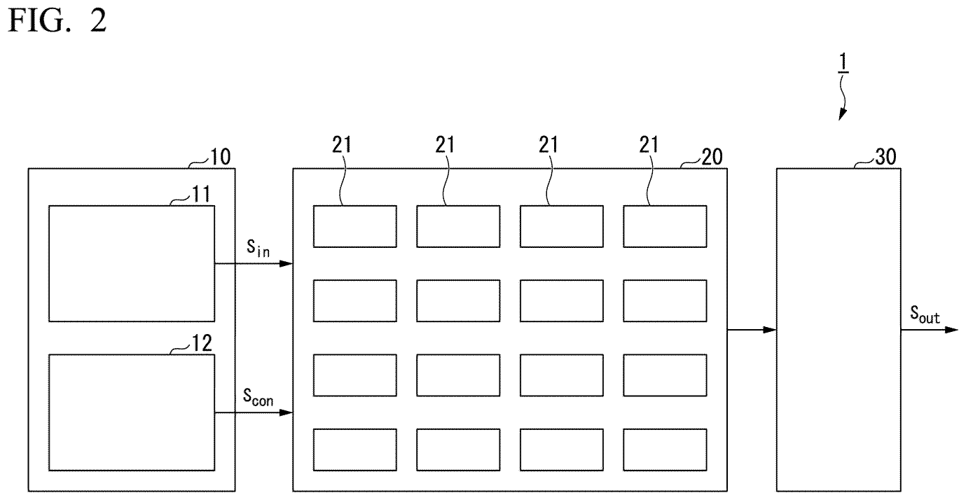

FIG. 2 is a configuration diagram of the information processing device 1 according to the first embodiment. For operating the neural network NN illustrated in FIG. 1, the neural network NN is formed as the information processing device 1.

The information processing device 1 includes an input unit 10, an information processing unit 20, and an output unit 30. The input unit 10 corresponds to the input layer Lᵢₙ illustrated in FIG. 1. The information processing unit 20 corresponds to the reservoir layer R illustrated in FIG. 1. The output unit 30 corresponds to the output layer out Lₒᵤₜ illustrated in FIG. 1.

The input unit 10 is configured to be able to input an input signal Sᵢₙ and a control signal S_{con} to a physical element 21 of the information processing unit 20. The input unit 10, for example, includes a first input unit 11 and a second input unit 12.

The first input unit 11 is configured to be able to input an input signal Sᵢₙ to the physical element 21. The first input unit 11 may be connected to each of a plurality of physical elements 21 present in the information processing unit 20 or may be connected only to some of the plurality of physical elements 21.

The first input unit 11, for example, has a sensor that detects input information. The first input unit 11 may have an analog digital converter, a digital-to-analog converter, or the like that converts a signal detected by the sensor.

The second input unit 12 is configured to be able to input a control signal S_{con} to the physical element 21. The second input unit 12 may be connected to each of the plurality of physical elements 21 present in the information processing unit 20 or may be connected only to some of the plurality of physical elements 21.

The second input unit 12, for example, has a power supply and a magnetic field source. The second input unit 12 is configured to be able to input an external force to the physical element 21. The external force, for example, is an electric field, a magnetic field, or the like.

The information processing unit 20 is connected to the input unit 10 and the output unit 30. The information processing unit 20 has a plurality of physical elements 21. The number of physical elements 21 of the information processing unit 20 is arbitrary. The physical elements 21 may be independent from each other or may be connected to each other. For example, the physical elements 21 may be randomly connected or may be connected in a ring form.

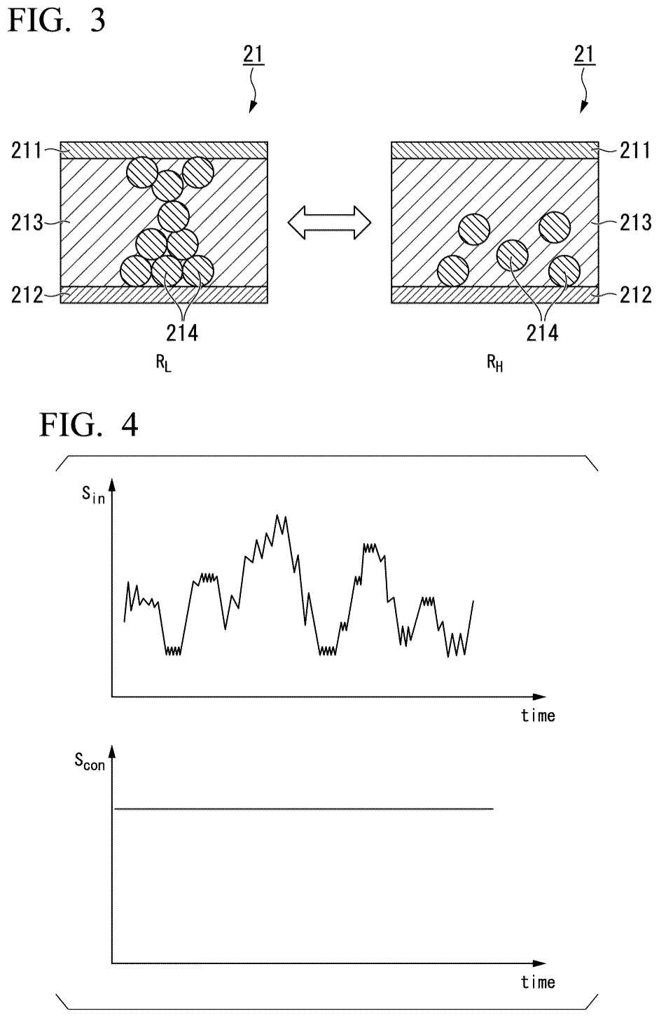

The physical element 21 is an element of which resistance or conductance changes in accordance with application of a voltage or a current. FIG. 3 is a diagram illustrating a physical element configuring the information processing device according to the first embodiment.

The physical element 21, for example, is a variable resistance memory. The physical element 21, for example, has a first electrode 211, a second electrode 212, an insulating layer 213, and conductive particles 214.

When an electric field in a first direction is applied between the first electrode 211 and the second electrode 212, the conductive particles 214 precipitate, and the physical element 21 enters a low-resistance state R_{L}. The reason for this is that the conductive particles 214 become a path through which electric charge between the first electrode 211 and the second electrode 212 passes. Hereinafter, an electric field in the first direction will be denoted as positive (+). When an electric field in a second direction is applied between the first electrode 211 and the second electrode 212, the physical element 21 enters a high-resistance state R_{H}. The reason for this is that a path through which electric charge between the first electrode 211 and the second electrode 212 passes disappears in accordance with the conductive particles 214. The second direction is a direction opposite to the first direction, and an electric field in the second direction will be denoted as negative (−). Here, although an example in which the resistance state of the physical element 21 is changed using an electric field is illustrated, the resistance state of the physical element 21 may be changed using a magnetic field.

The state of the physical element 21 changes between the low-resistance state R_{L} and the high-resistance state R_{H} when a voltage or a current is applied thereto. The conductance is a reciprocal of the resistance, and the conductance of the physical element 21 is also changed by applying a voltage or a current thereto.

The output unit 30 is connected to the information processing unit 20. The output unit 30 is configured to be able to receive a signal from the physical element 21 and output an output signal Sₒᵤₜ.

The output unit 30, for example, has an analog-to-digital converter, a product-sum operation circuit, a comparison circuit, and an output circuit. The analog-to-digital converter, for example, converts a signal from the physical element 21 into a digital signal. The product-sum operation circuit performs a product operation of applying a weight to a signal from each physical element 21 and a sum operation of adding results of the product operations. The comparison circuit compares a product-sum operation result with teacher data and adjusts weights to be applied to signals from the physical elements 21. The output circuit outputs an operation result to the outside.

The information processing device 1 may have components other than the input unit 10, the information processing unit 20, and the output unit 30. For example, the information processing device 1 may have a processor and a memory. The processor, for example, controls the operation of the information processing device 1. For example, the information processing device 1 performs a learning process or an inference process on the basis of an instruction from the processor. The memory, for example, has a program storage area storing a program and an information storage area storing information supplied from the information processing device 1. The memory, for example, is a dynamic random access memory (DRAM), a static random access memory (SRAM), a hard disk drive (HDD), a solid state drive (SSD), or the like.

Next, the operation of the information processing device 1 according to the first embodiment will be described.

The input unit 10 inputs an input signal Sᵢₙ and a control signal S_{con} to the physical element 21 of the information processing unit 20. The input signal Sᵢₙ, for example, is input from the first input unit 11. The control signal S_{con}, for example, is input from the second input unit 12.

The input signal Sᵢₙ is a signal that changes resistance or conductance of the physical element 21 on the basis of input information. The input information, for example, is a time series signal detected by a sensor. A type of sensor can be appropriately selected. For example, a temperature sensor, a humidity sensor, a pressure sensor, a magnetic field sensor, a speed sensor, an acceleration sensor, and the like are examples of the sensor that detects the input information.

The input signal Sᵢₙ may be input information itself or may be acquired by converting the input information. For example, the input signal Sᵢₙ may be acquired by performing time division of input information of a time series, or the input signal Sᵢₙ may be acquired by performing digital conversion of input information. The input signal Sᵢₙ may be input to all the physical elements 21 or may be input only to some of the physical elements 21. Input signals Sᵢₙ applied to respective physical elements 21 may be the same as or different from each other.

The control signal S_{con} is a signal that changes a change speed of the resistance or the conductance of the physical element 21. The control signal S_{con}, for example, is applied from a power supply. The control signal S_{con} may be input to all the physical elements 21 or may be input only to some of the physical elements 21. Control signals S_{con} applied to respective physical elements 21 may be the same as or different from each other.

In the case of the physical elements 21 illustrated in FIG. 3, both the input signal Sᵢₙ and the control signal S_{con} are applied between the first electrode 211 and the second electrode 212. FIG. 4 is a diagram illustrating one example of an input signal Sᵢₙ and a control signal S_{con} applied to one certain physical element 21.

The input signal Sᵢₙ changes in a time series on the basis of input information. An electric potential difference between the first electrode 211 and the second electrode 212 changes in accordance with the input signal Sᵢₙ, whereby the resistance of the physical element 21 changes.

The control signal S_{con}, for example, is applied in one direction with a constant intensity. For example, a positive voltage is applied between the first electrode 211 and the second electrode 212 as the control signal S_{con}. A force for maintaining the low-resistance state R_{L} of the physical element 21 is applied to the physical element 21 in accordance with the control signal S_{con}.

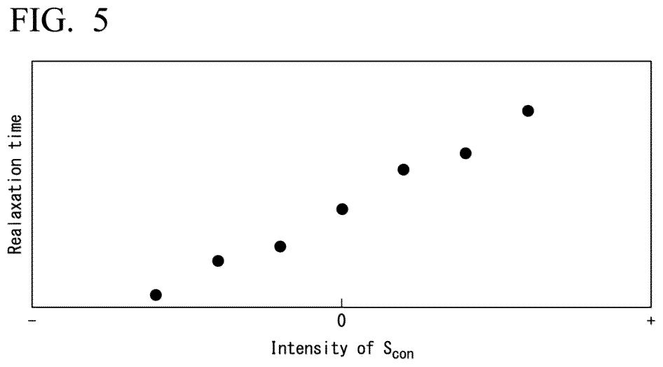

FIG. 5 is a diagram representing a relation between the control signal S_{con} applied to the physical element 21 and a relaxation time of the physical element 21 in the information processing device 1 according to the first embodiment.

The relaxation time is a time it takes to reach the high-resistance state R_{H} of the physical element 21 from the low-resistance state R_{L}. Unless an external force continues to be applied, the physical element 21 cannot continuously maintain the low-resistance state R_{L} and returns to the high-resistance state R_{H} in a constant relaxation time. The physical element 21 can maintain a signal applied to the physical element 21 in accordance with the input signal Sᵢₙ during the relaxation time. In other words, the physical element 21 can store past information during the relaxation time. The relaxation time corresponds to short term memory property (MC) of a neural network.

As illustrated in FIG. 5, when a positive voltage is continuously applied to the physical element 21 as the control signal S_{con}, the relaxation time is lengthened. In contrast, when a negative voltage is continuously applied to the physical element 21 as the control signal S_{con}, the relaxation time is shortened. The control signal S_{con} changes a change speed of the resistance or the conductance of the physical element 21. As illustrated in FIG. 5, by changing the relaxation time using the control signal S_{con}, the information processing device 1 according to this embodiment can change the short term memory property (MC) of the neural network.

An input signal Sᵢₙ input to the information processing unit 20 propagates between the physical elements 21, thereby being nonlinearly converted. Since each of the physical elements 21 maintains information of the past for the relaxation time, the input signal Sᵢₙ is nonlinearly converted also on the basis of the information of the past.

The nonlinearly converted signal reaches the output unit 30. Weights are applied to signals applied to the output unit 30, and a product-sum operation is performed therefor by the output unit 30. When the information processing device 1 performs learning, the output unit 30 compares a result of the product sum operation with teacher data and adjusts the weights. In a case in which the information processing device 1 performs inference, the output unit 30 outputs an output signal Sₒᵤₜ based on the result of the product sum operation. The output signal Sₒᵤₜ may be the result of the product sum operation or may be acquired by substituting the result of the product sum operation into an activation function.

In the information processing device 1 according to the first embodiment, the concept of the neural network NN is mounted not in software but in physical elements and circuits (hardware). A signal propagating inside hardware corresponds to an arithmetic operation in software. In the information processing device 1, the concept of the neural network NN is realized by hardware, whereby the operation load can be suppressed.

In addition, the information processing device 1 according to the first embodiment can freely design a relaxation time of the physical element 21 using the control signal S_{con}. Since the relaxation time of the physical element 21 corresponds to the short term memory property of the neural network, the information processing device 1 can freely design the short term memory property. For this reason, the information processing device 1 according to the first embodiment can adjust the short term memory property in accordance with a task, and the correct answer rate of an estimated solution of the information processing device 1 can be raised. For example, in a case in which the estimation accuracy is raised in a case in which relatively old data in time series data is taken into account, by raising the short term memory property, the correct answer rate of an estimated solution of the information processing device 1 can be raised.

Although one example of the information processing device 1 according to the first embodiment has been illustrated above, the information processing device 1 is not limited to this example, and various changes can be made in a range not departing from the concept.

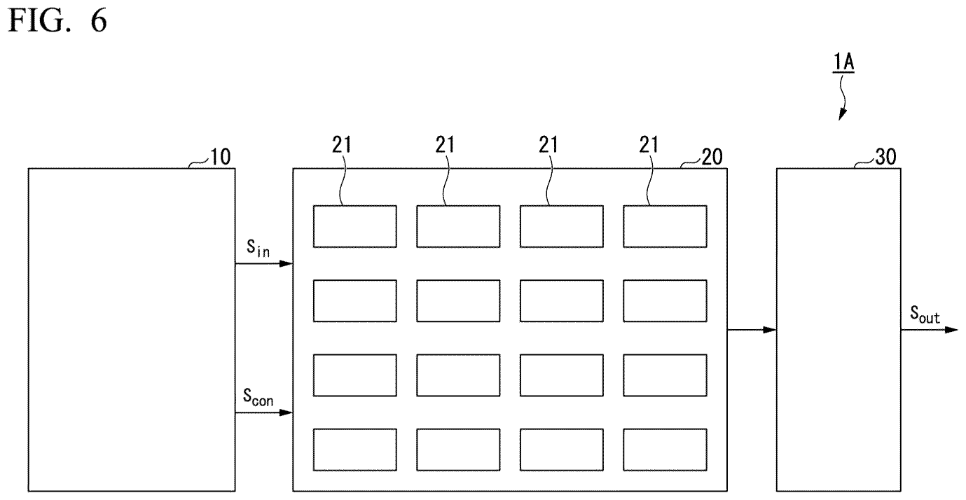

For example, FIG. 6 is a configuration diagram of a first modified example of the information processing device according to the first embodiment. In the information processing device 1A according to the first modified example, the input unit 10 is not clearly divided into the first input unit 11 and the second input unit 12, which is different from the information processing device 1.

The input unit 10 may be configured to be able to input an input signal Sᵢₙ and a control signal S_{con} to the physical element 21, and the first input unit 11 to which the input signal Sᵢₙ is applied and the second input unit 12 to which the control signal S_{con} is applied may not be clearly distinguished from each other.

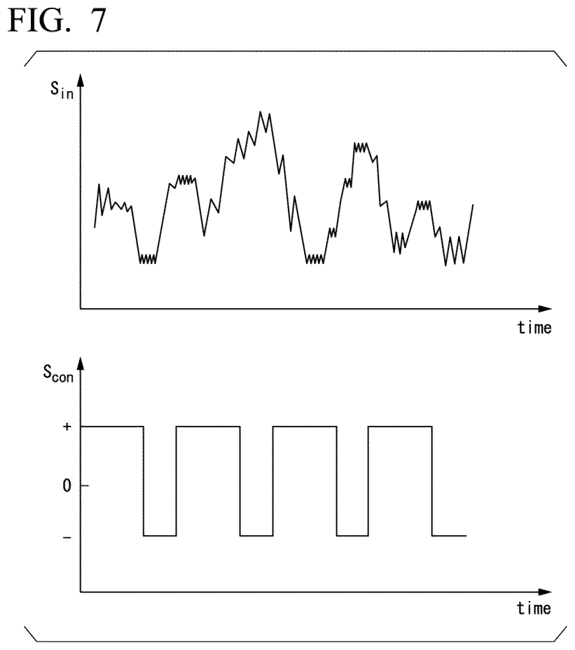

FIG. 7 is a diagram illustrating another example of the input signal Sᵢₙ and the control signal S_{con} of the information processing device 1 according to the first embodiment. As illustrated in FIG. 7, the control signal S_{con} may not be constant. For example, the control signal S_{con} may have a first signal and a second signal. The first signal is a signal that lowers a change speed of the resistance or the conductance of the physical element 21. The second signal is a signal that raises a change speed of the resistance or the conductance of the physical element 21. For example, the first signal is a voltage applied in a positive direction, and the second signal is a voltage applied in a negative direction.

Depending on a task given to the information processing device 1, for every elapse of a predetermined period, memory of the past may be removed. As illustrated in FIG. 7, after maintaining memory of the past for a predetermined period, using the first signal, memory of the past may be refreshed using the second signal.

In addition, in the description presented above, although an example in which the information processing unit 20 corresponds to the reservoir layer R illustrated in FIG. 1 has been illustrated, a mathematical model represented as the information processing unit 20 is not limited to reservoir computing. The mathematical model represented as the information processing unit 20 may be a recurrent neural network other than reservoir computing or may be a feedforward neural network having no recursive structure.

In addition, a physical element used in the information processing unit 20 is not limited to the physical element 21 illustrated in FIG. 3. The physical element, for example, may be a device that can convert an input signal into a vibration, an electromagnetic field, a magnetic field, a spin wave, or the like. For example, as the physical element, a MEMS microphone may be used, a spin torque oscillator (STO) may be used, or a magnetic domain wall moving element may be used.

The MEMS microphone can convert a vibration of a vibration membrane into an electric signal. The spin torque oscillator can convert an electric signal into a high frequency signal.

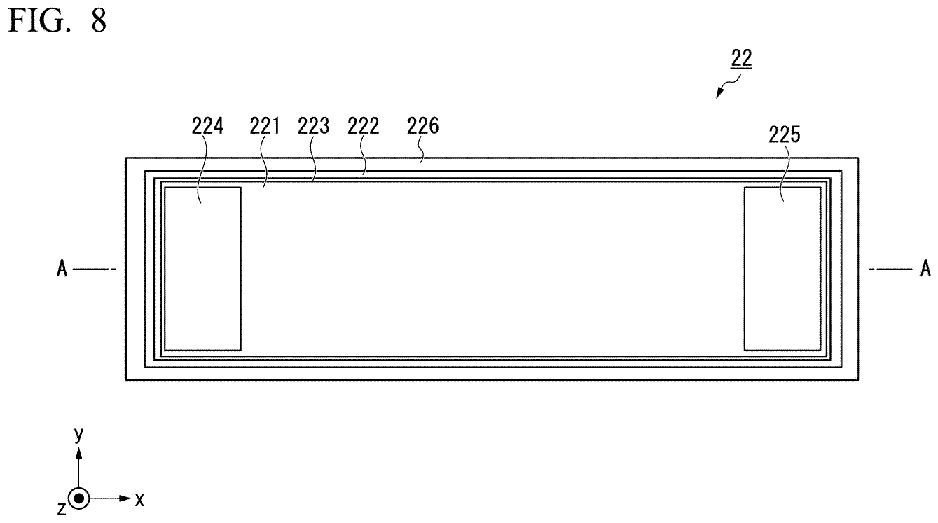

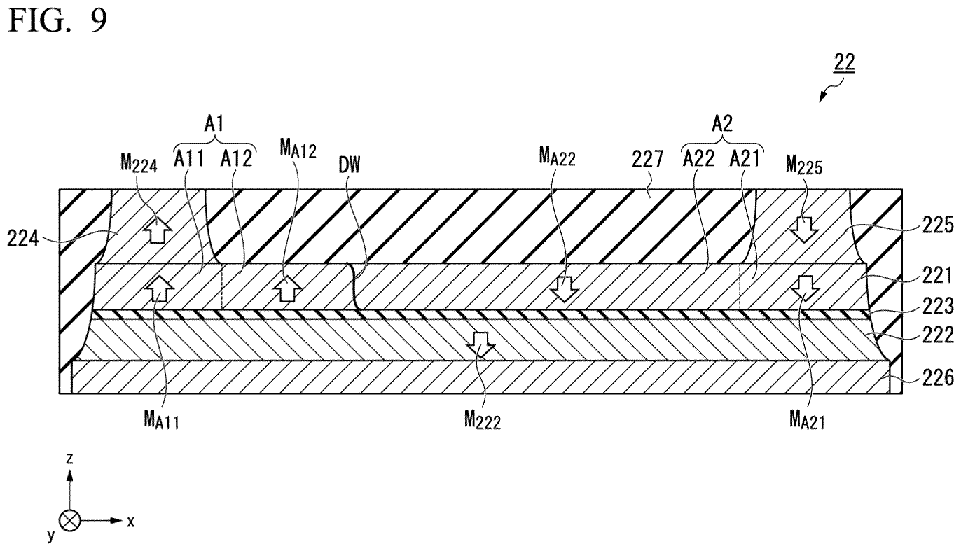

FIG. 8 is a plan view of a physical element (a magnetic domain wall moving element 22) used in the information processing unit 20. FIG. 9 is the physical element (the magnetic domain wall moving element 22) used in the information processing unit 20. The physical element illustrated in FIGS. 8 and 9 is a magnetic domain wall moving element of which resistance or conductance changes in accordance with the position of a domain wall DW.

The magnetic domain wall moving element 22 has a first ferromagnetic layer 221, a second ferromagnetic layer 222, a non-magnetic layer 223, a first electrode 224, a second electrode 225, and a third electrode 226. The magnetic domain wall moving element 22 has resistance or conductance in a stacking direction to be changed in accordance with a change in magnetization of the first ferromagnetic layer 221 and the second ferromagnetic layer 222 having the non-magnetic layer 223 interposed therebetween. The periphery of the magnetic domain wall moving element 22, for example, is covered with an insulating layer 227.

The first ferromagnetic layer 221 is a ferromagnetic layer including a ferromagnetic material. The first ferromagnetic layer 221 may be a ferromagnetic layer formed from a ferromagnetic material.

The ferromagnetic material, for example, may be a metal selected from a group composed of Cr, Mn, Co, Fe, and Ni, an alloy containing one or more types of such metals, or an alloy containing such metals and at least one or more types of elements among B, C, and N. The ferromagnetic material, for example, may contain any one selected from a group of a CoPt alloy, a CoNi alloy, a TbFeCo alloy, and a CoFe alloy, and alloys acquired by substituting a part of such alloys. The ferromagnetic material, for example, is Co—Fe, Co—Fe—B, or Ni—Fe.

The ferromagnetic material, for example, may be a Heusler alloy. A Heusler alloy is a half metal and has high spin polarizability. Heusler alloys are intermetallic compounds with the chemical composition XYZ or X₂YZ. Here, X is a transition metal element from the Co, Fe, Ni, or Cu groups or a noble metal element. Y is a transition metal from the Mn, V, Cr, or Ti groups or an element type of X, and Z is a typical element of any one of groups III to V. Examples of Heusler alloys include Co₂FeSi, Co₂FeGe, Co₂FeGa, Co₂MnSi, Co₂Mn₁₋ₐFeₐA1_{b}Si_{1-b}, Co₂FeGe_{1-c}Ga_{c}, and the like.

The first ferromagnetic layer 221 has a first magnetic domain A1 and a second magnetic domain A2. On the boundary between the first magnetic domain A1 and the second magnetic domain A2, a domain wall DW is present.

The domain wall DW is configured to be able to move at least an area of the first ferromagnetic layer 221, which overlaps the non-magnetic layer 223 in the stacking direction, in one direction within the plane of the first ferromagnetic layer 221. For example, the domain wall DW is configured to be able to move inside the first ferromagnetic layer 221 in an x direction. The x direction is one direction within a plane on which each layer expands. A y direction is a direction orthogonal to the x direction within the plane in which each layer expands. A z direction is a direction that is orthogonal to the x direction and the y direction.

When an electric potential difference between the first electrode 224 and the second electrode 225 is changed, the domain wall DW moves in the x direction. The domain wall DW, for example, moves when a write current (for example, a current pulse) is applied in the x direction of the first ferromagnetic layer 221, an external magnetic field is applied to the first ferromagnetic layer 221, or the like. For example, when a write pulse is applied between the first electrode 224 and the second electrode 225, the domain wall DW moves. The position of the domain wall DW changes in accordance with an input signal Sᵢₙ, whereby the resistance or the conductance of the magnetic domain wall moving element changes.

The first magnetic domain A1 has a first area A11 and a second area A12. The magnetization inside of the first magnetic domain A1 is aligned in the same direction. The magnetization M_{A11} of the first area A11 and the magnetization M_{A12} of the second area A12 are aligned in the same direction.

The first area A11 is an area overlapping the first electrode 224 when seen in the z direction and is an area in which the magnetization MA11 is fixed. The magnetization being fixed represents that magnetization is not reversed in a normal operation of the magnetic domain wall moving element 22 (an external force exceeding an assumed external force is not applied). The first area A11 is referred to as a first magnetization fixed area.

The second area A12 is an area other than the first area A11 inside the first magnetic domain A1. The volume of the second area A12 changes in accordance with movement of the domain wall DW.

The second magnetic domain A2 has a third area A21 and a fourth area A22. The magnetization inside of the second magnetic domain A2 is aligned in the same direction. The magnetization inside of the second magnetic domain A2 is aligned in a direction different from that of the magnetization inside of the first magnetic domain A1. The magnetization M_{A21} of the third area A21 and the magnetization M_{A22} of the fourth area A22 are aligned in the same direction.

The third area A21 is an area overlapping the second electrode 225 when seen in the z direction and is an area in which the magnetization MA21 is fixed. The third area A21 is referred to as a second magnetization fixed area.

A fourth area A22 is an area other than the third area A21 inside of the second magnetic domain A2. The volume of the fourth area A22 changes in accordance with movement of the domain wall DW.

The second area A12 and the fourth area A22 are altogether referred to as a domain wall moving area. The domain wall moving area is interposed between a first magnetization fixing area and a second magnetization fixing area.

The second ferromagnetic layer 222 comes into contact with the non-magnetic layer 223. The first ferromagnetic layer 221 and the second ferromagnetic layer 222 have the non-magnetic layer 223 interposed therebetween.

The second ferromagnetic layer 222 is a ferromagnetic layer that includes a ferromagnetic material. The second ferromagnetic layer 222 may be a ferromagnetic layer that is formed from a ferromagnetic layer. In the second ferromagnetic layer 222, a material similar to the material composing the first ferromagnetic layer 221 can be used. The material composing the second ferromagnetic layer 222 and the material composing the first ferromagnetic layer 221 may be the same or may be different from each other. It is more difficult to reverse the magnetization M₂₂₂ of the second ferromagnetic layer 222 than the magnetization of the first ferromagnetic layer 221.

The non-magnetic layer 223 is interposed between the first ferromagnetic layer 221 and the second ferromagnetic layer 222. The non-magnetic layer 223 is formed from a non-magnetic material. The non-magnetic layer 223 may be a conductor, a semiconductor, or an insulator. The non-magnetic layer 223, for example, may be MgO or Mg—A1—O.

The first electrode 224 and the second electrode 225, for example, may be ferromagnetic layers. For example, a material similar to that of the first ferromagnetic layer 221 and the second ferromagnetic layer 222 can be applied to the first electrode 224 and the second electrode 225. The third electrode 226 comes into contact with the second ferromagnetic layer 222. The third electrode 226 is a conductor.

An input signal Sᵢₙ is applied between the first electrode 224 and the second electrode 225 of the magnetic domain wall moving element 22. A control signal S_{con}, for example, is applied between the first electrode 224 and the second electrode 225 of the magnetic domain wall moving element 22 as an electric field. In addition, the control signal S_{con}, for example, may be applied to the first ferromagnetic layer 221 of the magnetic domain wall moving element 22 as a magnetic field.

Unless an external force is applied to the magnetic domain wall moving element 22, the position of the domain wall DW does not change. For this reason, the resistance value of the magnetic domain wall moving element 22 does not naturally return to the initial state. Unless an external force is applied, the magnetic domain wall moving element 22 does not have a relaxation time. In the case of the magnetic domain wall moving element 22, the relaxation time is a time it takes to reach the high-resistance state R_{H} from the low-resistance state R_{L} or a time it takes to reach the low-resistance state R_{L} from the high-resistance state R_{H}.

When the control signal S_{con} is applied to the magnetic domain wall moving element 22, the domain wall DW moves to the position of a boundary between the first area A11 and the second area A12 or a boundary between the third area A21 and the fourth area A22. The resistance value of the magnetic domain wall moving element 22 returns to the initial state in accordance with application of the control signal S_{con}. When the control signal S_{con} is applied to the magnetic domain wall moving element 22, the magnetic domain wall moving element 22 has a relaxation time. In other words, by applying the control signal S_{con} to the magnetic domain wall moving element 22, a short term memory property can be given to the magnetic domain wall moving element 22. In addition, the movement speed of the domain wall DW can be freely controlled using the control signal S_{con}, and the short term memory property can be freely designed.

### Second Embodiment

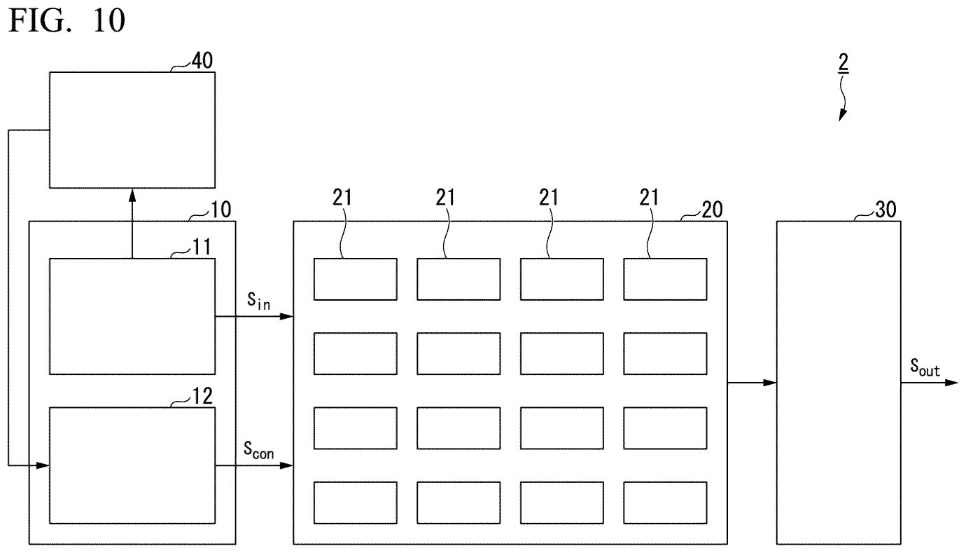

FIG. 10 is a configuration diagram of an information processing device 2 according to a second embodiment. The information processing device 2 further includes a signal monitoring unit 40, which is different from the information processing device 1 according to the first embodiment. In the information processing device 2, similar signs will be assigned to components similar to those of the information processing device 1, and description thereof will be omitted.

The signal monitoring unit 40 analyzes input information and determines a control signal S_{con} on the basis of a result of the analysis. The signal monitoring unit 40 analyzes the input information. The signal monitoring unit 40 may analyze the input information itself or may analyze an input signal Sᵢₙ based on the input information.

The signal monitoring unit 40, for example, monitors a time scale of input information. For example, in a case in which input information changes with a certain rule for each predetermined period, the time scale of the input information is a length of the predetermined period. In a case in which the time scale of input information is long, it is preferable that the relaxation time (corresponding to the short term memory property) of the physical element 21 be long. In a case in which the time scale of input information is short, it is preferable that the relaxation time (corresponding to the short term memory property) of the physical element 21 be short.

By monitoring input information using the signal monitoring unit 40, short term memory property that is appropriate for the input information can be selected. The signal monitoring unit 40 may monitor input information as required or may monitor input information for every predetermined period.

Since the information processing device 2 according to the second embodiment can freely control the short term memory property, effects similar to those of the information processing device 1 according to the first embodiment are acquired. In addition, since the information processing device 2 has the signal monitoring unit, the short term memory property can be optimized more easily.

Also in the information processing device 2 according to the second embodiment, modified examples similar to those of the information processing device 1 according to the first embodiment can be applied.

### EXPLANATION OF REFERENCES

1, 1A, 2 Information processing device
10 Input unit
11 First input unit

12 Second input unit
20 Information processing unit
21 Physical element
22 Magnetic domain wall moving element
30 Output unit
40 Signal monitoring unit
211, 224 First electrode
212, 225 Second electrode
213, 227 Insulating layer
214 Conductive particle
221 First ferromagnetic layer
222 Second ferromagnetic layer
223 Non-magnetic layer
226 Third electrode
A1 First magnetic domain
A2 Second magnetic domain
A11 First area
A12 Second area
A21 Third area
A22 Fourth area
DW Domain wall
R_{H} High-resistance state
R_{L} Low-resistance state
S_{con} Control signal
Sᵢₙ Input signal
Sₒᵤₜ Output signal

What is claimed is:

1. An information processing device comprising:
an input unit;
an information processing unit; and
an output unit,
wherein the information processing unit includes a physical element of which resistance or conductance changes in accordance with application of a voltage or a current,
wherein the input unit is configured to be able to input an input signal and a control signal to the physical element,
wherein the input signal is a signal for changing the resistance or the conductance of the physical element on the basis of input information,
wherein the control signal is a signal for changing a change speed of the resistance or the conductance of the physical element, and
wherein the output unit is configured to receive a signal from the physical element and output an output signal.

2. The information processing device according to claim 1,
wherein the input unit has a first input unit and a second input unit,
wherein the first input unit inputs the input signal to the physical element, and
wherein the second input unit inputs the control signal to the physical element.

3. The information processing device according to claim 1, further comprising a signal monitoring unit,
wherein the signal monitoring unit analyzes the input information and determines the control signal on the basis of a result of the analysis.

4. The information processing device according to claim 1, wherein the control signal is applied to the physical element as a magnetic field or an electric field.

5. The information processing device according to claim 1 wherein the control signal applied to the physical element is constant.

6. The information processing device according to claim 1,
wherein the control signal applied to the physical element has a first signal and a second signal,
wherein the first signal is a signal for lowering the change speed of the resistance or the conductance of the physical element, and
wherein the second signal is a signal for raising the change speed of the resistance or the conductance of the physical element.
